(19) United States
(12) Patent Application Publication
(10) Pub. No.: US 2015/0310677 A1
(43) Pub. Date: Oct. 29, 2015

(54) VEHICLE DIAGNOSIS SYSTEM

(71) Applicant: SOLWORKS CO., Ltd., Yongin-si (KR)

(72) Inventors: Ji Soo SHIN, Suwon-si (KR); Byoung Seoung Kang, Seongnam-si (KR); Kwang Ho Kim, Suwon-si (KR); Hyuk Kim, Yongin-si (KR)

(21) Appl. No.: 14/697,684

(22) Filed: Apr. 28, 2015

(30) Foreign Application Priority Data
Apr. 28, 2014 (KR) 10-2014-0050549

(51) Int. Cl. G07C 5/08; B60R 16/023

(52) U.S. Cl. CPC G07C 5/0808; B60R 16/023

(57) ABSTRACT

Disclosed is a vehicle diagnosis system including: a signal-collecting unit disposed at a proper place of the vehicle including CAN(Controller Area Network) communication modules which send a CAN signal to and receive it from a vehicle ECU for controlling states of all parts of the vehicle by a computer, through a CAN and which output an analog signal to a driver driven by the module according to a command from the vehicle ECU, wherein the signal-collecting unit synchronizes and collects the CAN signal and the analog signal at predetermined time intervals; and a diagnosing unit which detects changes of the CAN signal and the analog signal collected in the signal-collecting unit at synchronization collection periods, and if the change of any one of the two signals has not been detected, diagnoses that the CAN communication module outputting the relevant CAN signal and analog signal failed.

### TECHNICAL FIELD

The present invention relates to a vehicle diagnosis system, and more particularly, to a vehicle diagnosis system for diagnosing a failure of CAN communication modules which send a CAN signal to and receive it from a vehicle ECU(Electronic Control Unit) through a CAN(Controller Area Network).

### BACKGROUND ART

A vehicle ECU is a device for controlling all parts of vehicle such as driving system, braking system, steering system etc. of the vehicle.

For example, the vehicle ECU corrects a water temperature sensor, oxygen sensor etc. referring to a manifold absolute pressure value for ignition timing and a manifold absolute pressure value for fuel injection etc. each preset depending on a rotational number of engine, amount of intake air, intake pressure, opening degree of accelerator etc. in the driving system and adjusts an opening/closing rate of fuel injector, thereby determining an injection amount of fuel and ignition timing.

For controlling the driving system, braking system, steering system etc., the vehicle ECU sends a CAN signal to and receives it from a CAN communication module, which actually drives the driving system, braking system, steering system etc. of the vehicle, through the CAN.

The CAN is largely classified into a body-CAN and a chassis-CAN, and objects to be controlled may be variously determined depending on the types of vehicle.

For reference, Patent Document 1 discloses a vehicle CAN communication device for controlling the driving system, braking system, steering system etc. as described above.

The body-CAN connects the vehicle ECU with the CAN communication modules(hereinafter, referred to as body-CAN communication module) such as driver's seat-side door module, passenger's seat-side door module, power trunk module, steering tilt/telescopic module, smart key control module etc.

The chassis-CAN connects the vehicle ECU with the CAN communication module(hereinafter, referred to as chassis-CAN communication module) such as airbag control module, parking guide module, vehicle diagnosis module, electronic parking brake module, tire pressure-monitoring module, module for warning of deviation from lane, smart cruse control module, ABS control module etc.

The CAN communication modules as described above output an analog signal(for example, voltage signal or current signal) according to a commands from the vehicle ECU and drive a driver(for example, sensor or actuator) driven by the module.

For example, if the vehicle ECU transmits an CAN signal for door-up command to the driver's seat-side door module through the body-CAN according to an up/down operation of a driver's seat-side door switch, the driver's seat-side door module outputs an analog signal for raising the driver's seat-side door to drive an actuator for the driver's seat-side door, thereby raising the driver's seat-side door.

For example, if the vehicle ECU transmits an CAN signal for tire pressure monitoring command to the tire pressure-monitoring module through the chassis-CAN, the tire pressure-monitoring module outputs an analog signal for detecting the tire pressure to drive a tire pressure sensor, thereby detecting the tire pressure.

Meanwhile, the chassis-CAN communication module connected with the vehicle ECU through the chassis-CAN can be usually diagnosed for its failure by means of a portable vehicle-diagnosing device electrically connected to the vehicle-diagnosing module.

The portable vehicle-diagnosing device is carried by a technician in a vehicle repair shop and can easily make a diagnosis of failure while being connected to the vehicle-diagnosing module.

However, the body-CAN is not provided with the vehicle-diagnosing module, and therefore, unlike the chassis-CAN communication module, the body-CAN communication module is not easy to be diagnosed for its failure.

Actually, the body-CAN communication module has to be disassembled by the vehicle repair technician for the diagnosis of its failure and has to be diagnosed by a failure-diagnosing device separately produced for each body-CAN communication module or analog signal output from each body-CAN communication module is checked by analog signal-testing equipment such as multimeter or oscilloscope.

As above, in the case where the vehicle repair technician diagnoses the failure of body-CAN communication module by the use of the failure-diagnosing device separately produced or the analog signal-testing equipment, an operation of extracting effective data or signal from collected data or signals has to be manually performed, and thus the operation consumes a lot of time and is inefficient and efficiency and reliability of overall inspection and verification operations are lowered.

On the other hand, when the CAN-communication such as the chassis-CAN communication module or the body-CAN communication module failed, the module cannot output the analog signal to the driver(for example, sensor or actuator) driven by the module, and as a result, the relevant driver with no analog signal being input thereto is not driven even though the driver is in a normal condition. In such a case, the relevant driver may be unnecessarily repaired or replaced if the vehicle repair technician misjudges that the relevant driver has failed.

### Document of Prior Art Patent document 1: KR 10-2012-0119890 A

### SUMMARY OF THE INVENTION

### Technical Problems

The present invention is for solving the problem as described above, and its object is to provide a vehicle diagnosis system for making a diagnosis of failure of CAN communication modules which send a CAN signal to and receive it from a vehicle ECU for controlling states of all parts of the vehicle such as driving system, braking system, steering system etc. of the vehicle by a computer, through a CAN and which output an analog signal to a driver(for example, sensor or actuator) driven by the module according to a command from vehicle ECU, by synchronizing and collecting the CAN signal and the analog signal at predetermined time intervals and based on a result of detection of changes of the two signals.

### Solution to the Problem

To achieve the above object of the present invention, a vehicle diagnosis system according to the present invention includes a signal-collecting unit disposed at a proper place of the vehicle including CAN communication modules which send a CAN signal to and receive it from a vehicle ECU for controlling states of all parts of the vehicle by a computer, through a CAN and which output an analog signal to a driver (for example, sensor or actuator) driven by the module according to a command from the vehicle ECU, wherein the signal-collecting unit synchronizes and collects the CAN signal and the analog signal at predetermined time intervals; and a diagnosing unit which detects changes of the CAN signal and the analog signal collected in the signal-collecting unit at synchronization collection periods, i.e. at the predetermined time interval, and if the change of any one of the two signals has not been detected, diagnoses that the CAN communication module outputting the relevant CAN signal and analog signal failed.

### Effects of the Invention

The present invention does not need to use the conventional portable vehicle diagnosis device or the failure-diagnosing device separately produced for each CAN communication module or the analog signal-testing equipment such as multimeter or oscilloscope, and regardless of types of the CAN for connecting the CAN communication module and the vehicle ECU for controlling states of all parts of the vehicle by a computer, that is, whether the chassis-CAN communication module connected to the vehicle ECU through the chassis-CAN or the body-CAN communication module connected to the vehicle ECU through the body-CAN for example, it is possible to quickly accurately and easily diagnose whether all CAN communication modules installed in the vehicle failed or not.

### BRIEF DESCRIPTION OF THE DRAWINGS

FIG. 1 is a block diagram showing a construction of a vehicle diagnosis system according to the present invention;

FIG. 2 is a block diagram showing a construction of a signal-collecting unit of FIG. 1;

FIG. 3 is a block diagram showing a construction of a diagnosing unit of FIG. 1;

FIG. 4 is a flowchart showing an operational process of a diagnosing part; and

FIG. 5 is a graph showing a result of the diagnosis of failure by the diagnosing part.

### BEST MODES FOR CARRYING OUT THE INVENTION

Hereinafter, a preferred embodiment of the present invention will be described in more detail with reference to the attached drawings.

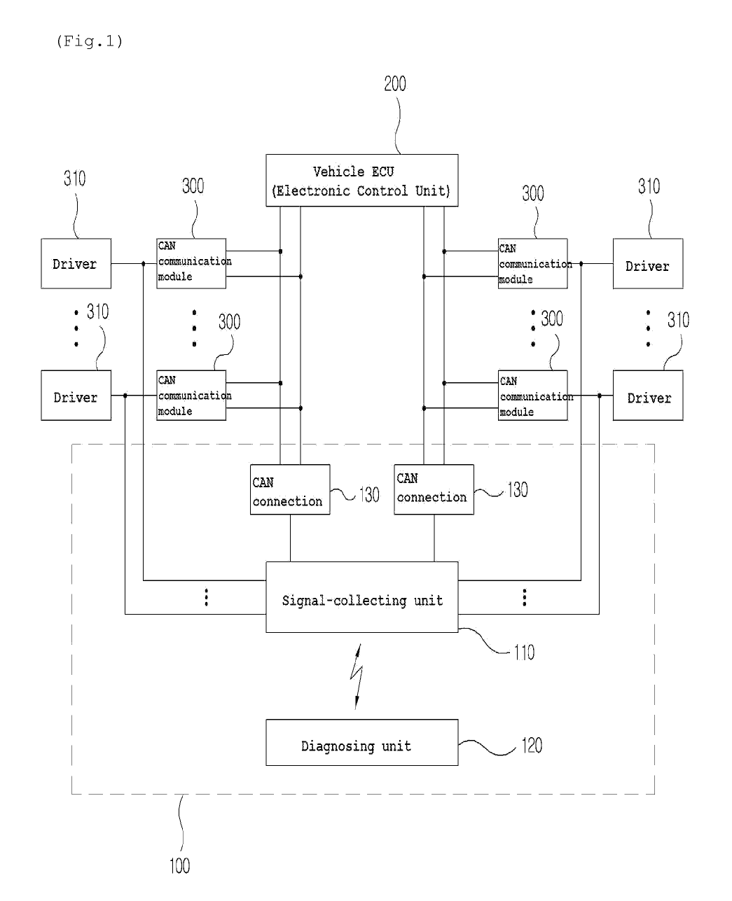

Referring to FIG. 1, a vehicle diagnosis system (100) according to the present invention includes a signal-collecting unit (110) and a diagnosing unit (120).

The signal-collecting unit (110) and the diagnosing unit (120) communicate with each other through a wireless communication network such as wireless internet or mobile communication network etc. or through a wired communication network such as wired internet or LAN etc.

The signal-collecting unit (110) is disposed at a proper place of the vehicle (for example, a trunk or a bottom of passenger's seat) including CAN communication modules (300) which send a CAN signal to and receive it from a vehicle ECU (200) for controlling states of all parts of vehicle such as driving system, braking system, steering system etc. of the vehicle by a computer, through a CAN and which output an analog signal to a driver (310) (for example, sensor or actuator) driven by the module according to a command from the vehicle ECU (200), and the signal-collecting unit synchronizes and collects the CAN signal and the analog signal at predetermined time intervals.

The signal-collecting unit (110) collects the CAN signal through at least one CAN connection (130) corresponding to at least one CAN one to one, and the CAN signal is a digital signal including an identifier of the CAN communication module (300).

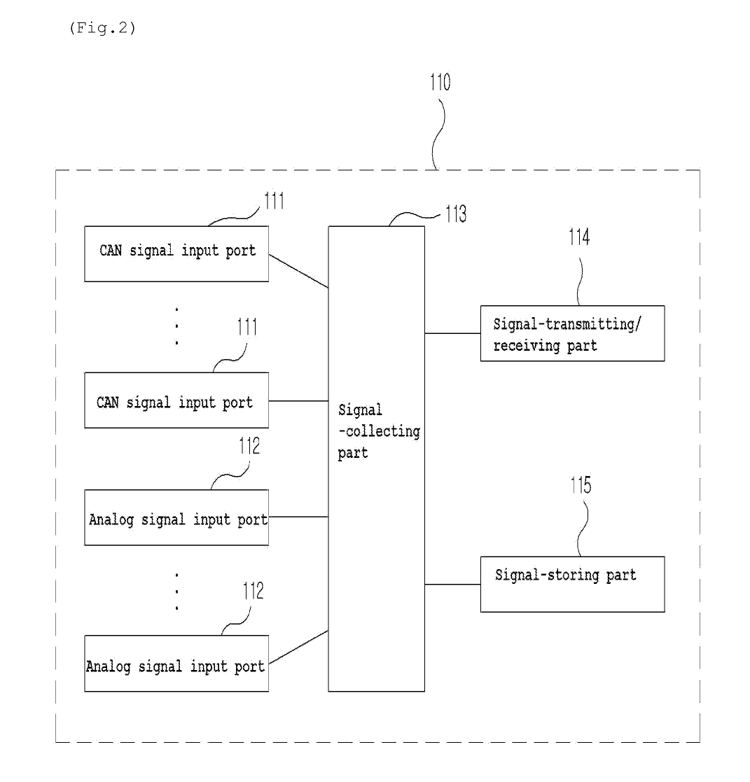

Referring to FIG. 2, at least one CAN signal input port (111) of the signal-collecting unit (110) collects a digital CAN signal including the identifier of the CAN communication module (300) through the at least one CAN connection (130) corresponding to the at least one CAN one to one and corresponds to the at least one CAN connection (130) one to one.

At least one analog signal input port (112) of the signal-collecting unit (110) corresponds to the CAN communication modules (300) one to one to collect the analog signal. A signal-collecting part (113) of the signal-collecting unit (110) synchronizes and collects the CAN signal and the analog signal at the predetermined time intervals through the CAN signal input port (111) and the analog signal input port (112), and the analog signal is collected after converted into a digital signal.

A signal-transmitting/receiving part (114) of the signal-collecting unit (110) transmits the CAN signal and the analog signal collected in the signal-collecting part (113) to the diagnosing unit (120) through the wireless communication network or the wired communication network in response to a request from the diagnosing unit (120).

A signal-storing part (115) of the signal-collecting unit (110) stores the CAN signal and the analog signal collected in the signal-collecting part (113).

The signal-storing part (115) can be applied to the present invention in any form (for example, USB memory, external hard disk or the like) as long as it is a memory separable from the signal-collecting unit (110).

The diagnosing unit (120) detects changes of the CAN signal and the analog signal collected in the signal-collecting unit (110) at synchronization collection periods, i.e. at predetermined time intervals and if the change of any one of the two signals has not been detected, the diagnosing unit diagnoses that the CAN communication module (300) outputting the relevant CAN signal and analog signal failed.

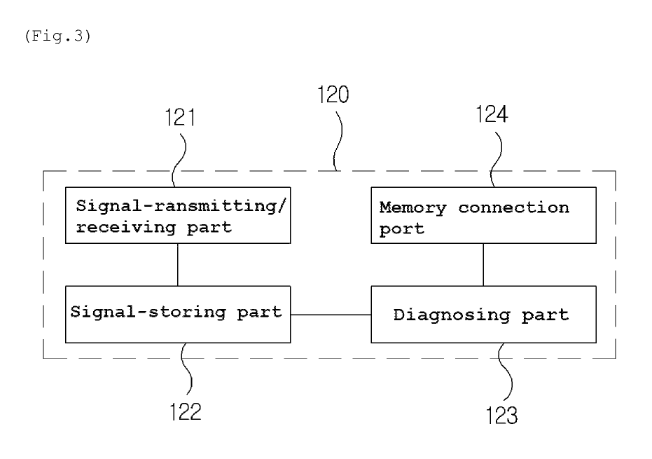

Referring to FIG. 3, the signal-transmitting/receiving part (121) of the diagnosing unit (120) receives the CAN signal and the analog signal collected in the signal-collecting unit (110) through the wireless communication network or wired communication network.

A signal-storing part (122) of the diagnosing unit (120) stores the CAN signal and the analog signal collected in the signal-collecting unit (110) through the signal-transmitting/receiving part (121).

The diagnosing part (123) of the diagnosing unit (120) reads out, from the signal-storing part (122), the CAN signal and the analog signal synchronized and collected at the predetermined time intervals and diagnoses whether the CAN communication module (300) outputting the relevant CAN signal and analog signal failed or not based on a result of detection of the changes of two signals.

The diagnosing unit (120) further includes a memory connection port (124) connected to a memory(for example, USB memory, external hard disk etc.) which stores the CAN signal and the analog signal synchronized and collected at the predetermined time intervals and from which the diagnosing part (123) can read out the signals.

The memory connected to the memory connection port (124) is preferably the signal-storing part (115) separable from the signal-collecting unit (110).

The diagnosing part (123) reads out, from the signal-storing part (115) connected to the memory connection port (124), the CAN signal and the analog signal synchronized and collected at the predetermined time intervals and diagnoses whether the CAN communication module (300) outputting the relevant CAN signal and analog signal failed or not based on the result of detection of the changes of two signals.

If the change of the CAN signal collected at the synchronization collection periods, i.e. at the predetermined time intervals has been detected and the change of the analog signal has not been detected as the result of detection of the changes of the CAN signal and analog signal or if the change of the analog signal has been detected and the change of the CAN signal has not been detected, the diagnosing part (123) diagnoses that the CAN communication module (300) outputting the relevant CAN signal and analog signal failed.

In the following, operation of the vehicle diagnosis system (100) according to the present invention configured as above will be described.

The signal-collecting unit (110) is preferably disposed at the trunk or bottom of passenger's seat of the vehicle etc. for example.

The vehicle with the signal-collecting unit (110) disposed therein includes the CAN communication modules (300) which send the CAN signal to and receives it from the vehicle ECU (200) for controlling the states of all parts of vehicle such as the driving system, braking system, steering system etc. by a computer, through the CAN, and which outputs the analog signal to the driver (300) (for example, sensor or actuator) driven by the module according to the command from vehicle ECU (200).

For diagnosing the failure of the CAN communication modules, the signal-collecting unit (110) synchronizes and collects, at predetermined time intervals, the digital CAN signal by which the relevant CAN communication module receives the command from the vehicle ECU (200) and sends its response to the vehicle ECU and the analog signal(for example, voltage signal or current signal) which the module outputs for driving the driver(for example, sensor or actuator) driven by the module according to the command from the vehicle ECU (200).

At this time, the signal-collecting part (113) synchronizes and collects the CAN signal and the analog signal at predetermined time intervals through the CAN signal input port (111) and the analog signal input port (112), and collects the analog signal after converting it into the digital signal.

The CAN signal and the analog signal collected as above are transmitted from the signal-collecting unit (110) to the diagnosing unit (120) in response to a request from the diagnosing unit (120).

At this time, the CAN signal and the analog signal collected in the signal-collecting part (113) are transmitted to the diagnosing unit (120) via the signal-transmitting/receiving part (114) through the wireless communication network or wired communication network.

The CAN signal and the analog signal transmitted to the diagnosing unit (120) as above are stored in the signal-storing part (122) via the signal-transmitting/receiving part (121).

Thereafter, the diagnosing part (123) reads out, from the signal-storing part (122), the CAN signal and the analog signal synchronized and collected at predetermined time intervals and diagnoses whether the CAN communication module (300) outputting the relevant CAN signal and analog signal failed or not based on a result of detection of the changes of two signals.

In the following, a detailed description will be made of process of the diagnosing part (123) diagnosing whether the CAN communication module (300) outputting the CAN signal and the analog signal filed or not.

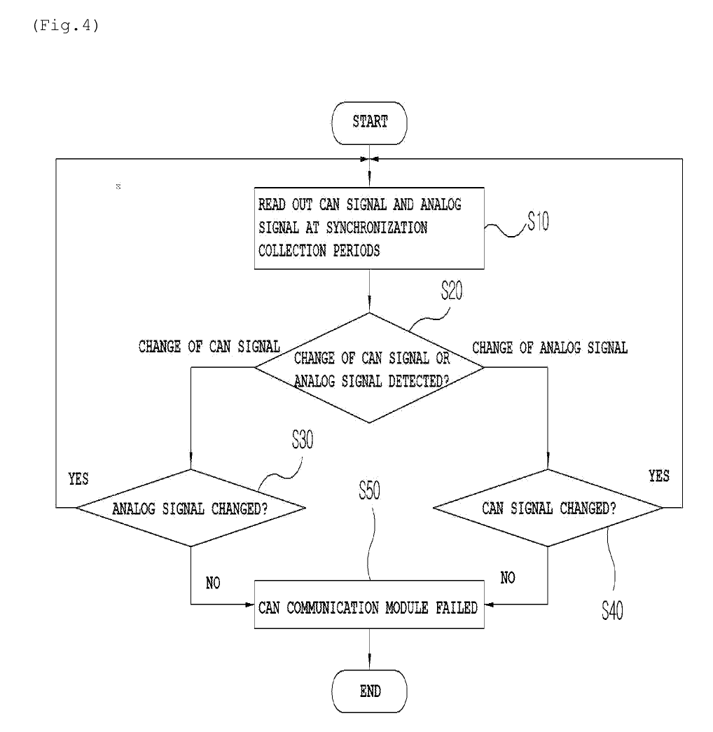

FIG. 4 is a flowchart showing an operational process of the diagnosing part (123).

Referring to FIG. 4, the diagnosing part (123) reads out the CAN signal and the analog signal synchronized and collected at predetermined time intervals from the signal-storing part (122) or from the signal-storing part (115) (for example, USB memory, external hard disk etc.) separated from the signal-collecting unit (110) and connected to the memory connection port (124)(S10).

Subsequently, the diagnosing part (123) detects the changes of the two signals(S20).

At this time, if the change of the CAN signal has been detected, the diagnosing part (123) subsequently detects the change of the analog signal (S30).

If the change of the CAN signal collected for the synchronization collection period, i.e. at the predetermined time interval has been detected and the change of analog signal has not been detected, the diagnosing part (123) diagnoses that the CAN communication module (300) outputting the relevant CAN signal and analog signal failed (S50).

To the contrary, if the change of the analog signal has been detected as the result of detection of the changes of the two signals by the diagnosing part (123)(S20), the diagnosing part (123) subsequently detects the changes of the CAN signal (S40).

If the change of the analog signal collected for the synchronization collection period, i.e. at the predetermined time interval has been detected and the change of the CAN signal has not been detected, the diagnosing part (123) diagnoses that the CAN communication module (300) outputting the relevant CAN signal and analog signal failed (S50).

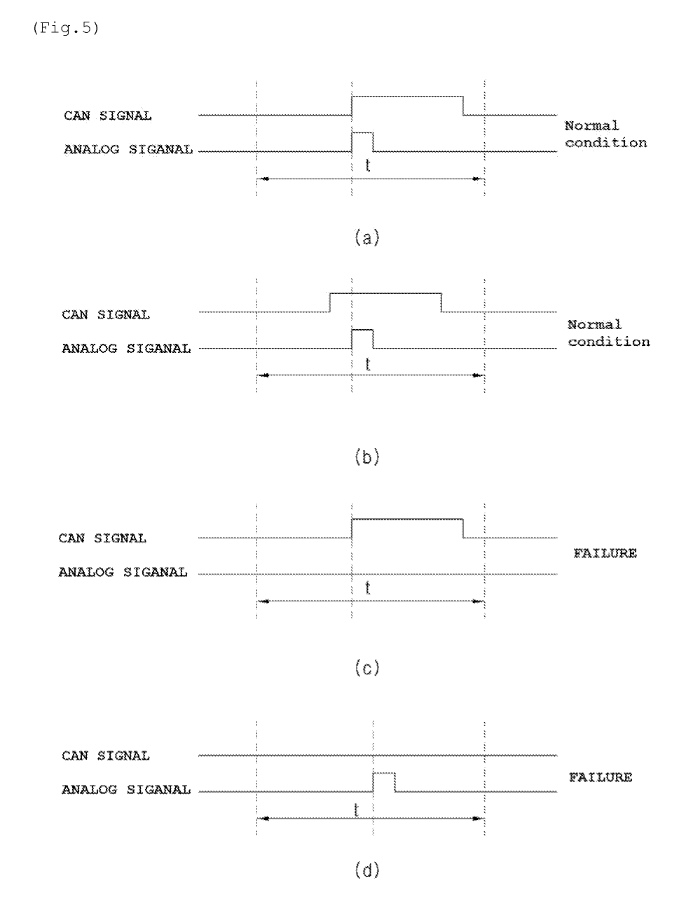

FIG. 5 is a graph showing the result of the diagnosis of failure by the diagnosing part (123).

If the CAN communication module (300) outputting the CAN signal and analog signal is normal, most preferably, the change of the CAN signal occurs and at the same time the change of the analog signal occurs for the synchronization collection period, i.e. at the predetermined time interval(t), as shown in FIG. 5(a), or the change of the analog signal occurs after the change of the CAN signal with a slight time delay, as shown in FIG. 5(b).

To the contrary, if the CAN communication module (300) outputting the CAN signal and analog signal failed, the change of the analog signal does not occur even though the change of the CAN signal occurs for the synchronization collection period, i.e. at the predetermined time interval(t), as shown in FIG. 5(c), or the change of the CAN signal does not occur even though the change of the analog signal occurs, as shown in FIG. 5(d).

As may be seen from the above, the present invention does not need to use the conventional portable vehicle diagnosis device or the failure-diagnosing device separately produced for each CAN communication module or the analog signal-testing equipment such as multimeter or oscilloscope which are all mentioned in the description of prior art.

According to the present invention, if the change of any one of the CAN signal and the analog signal collected in the signal-collecting unit (110) at synchronization collection periods, i.e. at the predetermined time intervals has not been detected as the result of the detection of changes of the two signals, the diagnosing unit (120) diagnoses that the CAN communication module (300) outputting the relevant CAN signal and analog signal failed, and therefore, regardless of types of the CAN for connecting the vehicle ECU (200) and the CAN communication module (300), that is, whether the chassis-CAN communication module connected to the vehicle ECU (200) through the chassis-CAN or the body-CAN communication module connected to the vehicle ECU (200) through the body-CAN for example, it is possible to quickly accurately and easily diagnose whether all CAN communication modules (300) installed in the vehicle failed or not.

The vehicle diagnosis system according to the present invention described above is not limited to the embodiment described above, and those skilled in the art may make various modifications of the embodiment without departing from the gist of the present invention defined by the following claims.

### DESCRIPTION OF REFERENCE NUMERALS

100: vehicle diagnosis system
110: signal-collecting unit
111: CAN signal input port
112: analog signal input port
113: signal-collecting part
114: signal-transmitting/receiving part
115: signal-storing part
120: diagnosing unit
121: signal-transmitting/receiving part
122: signal-storing part
123: diagnosing part
124: memory connection port
130: CAN connection
200: vehicle ECU(Electronic Control Unit)
300: CAN communication module
310: driver

What is claimed is:

1. A vehicle diagnosis system comprising:
a signal-collecting unit (110) disposed at a proper place of the vehicle including CAN(Controller Area Network) communication modules (300) which send a CAN signal to and receive it from a vehicle ECU (200) for controlling states of all parts of the vehicle by a computer, through a CAN and which output an analog signal to a driver (310) driven by the module according to a command from the vehicle ECU (200), wherein the signal-collecting unit synchronizes and collects the CAN signal and the analog signal at predetermined time intervals; and
a diagnosing unit (120) which detects changes of the CAN signal and the analog signal collected in the signal-collecting unit (110) at synchronization collection periods, i.e. at the predetermined time interval, and if the change of any one of the two signals has not been detected, diagnoses that the CAN communication module (300) outputting the relevant CAN signal and analog signal failed.

2. The vehicle diagnosis system according to claim 1, wherein the signal-collecting unit (110) collects the CAN signal through at least one CAN connection (130) corresponding to at least one CAN one to one, and the CAN signal is a digital signal including an identifier of the CAN communication module (300).

3. The vehicle diagnosis system according to claim 1, wherein the signal-collecting unit (110) comprises:
at least one CAN signal input port (111) which collects a digital CAN signal including the identifier of the CAN communication module (300) through the at least one CAN connection (130) corresponding to the at least one CAN one to one and which corresponds to the at least one CAN connection (130) one to one;
at least one analog signal input port (112) which corresponds to the CAN communication modules (300) one to one to collect the analog signal; and
a signal-collecting part (113) which synchronizes and collects the CAN signal and the analog signal at the predetermined time intervals through the CAN signal input port (111) and the analog signal input port (112), wherein the analog signal is collected after converted into a digital signal.

4. The vehicle diagnosis system according to claim 3, wherein the signal-collecting unit (110) further comprises a signal-transmitting/receiving part (114) which transmits the CAN signal and the analog signal collected in the signal-collecting part (113) to the diagnosing unit (120) through wireless communication network or wired communication network in response to a request from the diagnosing unit (120).

5. The vehicle diagnosis system according to claim 3, wherein the signal-collecting unit (110) further comprises a signal-storing part (115) which stores the CAN signal and the analog signal collected in the signal-collecting part (113).

6. The vehicle diagnosis system according to claim 5, wherein the signal-storing part (115) is a memory separable from the signal-collecting unit (110).

7. The vehicle diagnosis system according to claim 1, wherein the diagnosing unit (120) comprises:
a signal-transmitting/receiving part (121) which receives the CAN signal and the analog signal collected in the signal-collecting unit (110) through the wireless communication network or wired communication network;
a signal-storing part (122) which stores the CAN signal and the analog signal collected in the signal-collecting unit (110) through the signal-transmitting/receiving part (121); and
a diagnosing part (123) which reads out, from the signal-storing part (122), the CAN signal and the analog signal synchronized and collected at the predetermined time intervals and diagnoses whether the CAN communication module (300) outputting the relevant CAN signal and analog signal failed or not based on a result of detection of the changes of two signals.

8. The vehicle diagnosis system according to claim 7, wherein the diagnosing unit (120) further comprises a memory connection port (124) connected to a memory which stores the CAN signal and the analog signal synchronized and collected at the predetermined time intervals and from which the diagnosing part (123) can read out the signals, and wherein the memory connected to the memory connection port (124) is the signal-storing part (115) of the signal-collecting unit (110) separable from the signal-collecting unit (110).

9. The vehicle diagnosis system according to claim 8, wherein the diagnosing part (123) reads out, from the signal-storing part (115) of the signal-collecting unit (110) connected to the memory connection port (124), the CAN signal and the analog signal synchronized and collected at the predetermined time intervals and diagnoses whether the CAN communication module (300) outputting the relevant CAN signal and analog signal failed or not based on the result of detection of the changes of two signals.

10. The vehicle diagnosis system according to claim 7, wherein if the change of the CAN signal collected at the synchronization collection periods, i.e. at the predetermined time intervals has been detected and the change of the analog signal has not been detected as the result of detection of the changes of the CAN signal and analog signal or if the change of the analog signal has been detected and the change of the CAN signal has not been detected, the diagnosing part (123) diagnoses that the CAN communication module (300) outputting the relevant CAN signal and analog signal failed.
